(19) United States
(12) Patent Application Publication
(10) Pub. No.: US 2025/0310741 A1
(43) Pub. Date: Oct. 2, 2025

(54) VEHICLES EQUIPPED WITH MULTIPLE COMMUNICATION MODULES AND METHODS OF CONTROLLING THE SAME

(71) Applicants: HYUNDAI MOTOR COMPANY, Seoul (KR); KIA CORPORATION, Seoul (KR)

(72) Inventor: Seong Soo YAE, Hwaseong-si (KR)

(21) Appl. No.: 18/969,996

(22) Filed: Dec. 5, 2024

(30) Foreign Application Priority Data
Apr. 2, 2024 (KR) 10-2024-0044829

(51) Int. Cl. H04W 4/50; H04W 4/40; H04W 28/16

(52) U.S. Cl. CPC H04W 4/50; H04W 4/40; H04W 28/16

(57) ABSTRACT

A controlling method of a vehicle, comprising setting, by a processor executing computer program stored in a memory, one of a plurality of communication modules as an external module and the remaining communication modules of the plurality of communication modules as internal modules, analyzing, by the processor executing the computer program, a bandwidth by service in the external device and a service table by module related to a service status of each of the internal modules based on a connection of the vehicle to an external device through the external module, and controlling, by the processor executing the computer program, to allocate at least one or more services to a connection between the external module and each of the internal modules based on a result of the analyzing.

### CROSS-REFERENCE TO RELATED APPLICATION

The present application claims priority to Korean Patent Application No. 10-2024-0044829, filed on Apr. 2, 2024, the entire contents of which are incorporated herein for all purposes by this reference.

### TECHNICAL FIELD

The present disclosure relates to a vehicle equipped with multiple communication modules and methods of controlling the same.

### BACKGROUND

A vehicle is a machine designed to drive wheels and move along roads to transport passengers or cargo.

In addition to driving functionality, a vehicle may perform various user convenience functions, such as an audio and video playback, navigation, climate control, seat heating, and communication with external terminals.

A vehicle includes a head unit for controlling these convenience functions, as well as input and output devices to facilitate the entry and display of operation information related to these functions.

The vehicle may further include a server and a communication module to enable connectivity with base stations and external user terminals. Through this communication module, the vehicle can transmit and receive information to and from external devices, with output provided via a speaker, a display unit, and a vehicle terminal.

Recently, with an increase in external devices and a rise in service connectivity through the communication module of the vehicle, bandwidth demands have escalated. This trend has led to issues where a single communication module cannot sustain operational requirements, and the load of the communication module increases rapidly due to growing number of connected services.

### SUMMARY

The present disclosure is directed to a vehicle including a plurality of communication modules for improving communication services and a controlling method of the vehicle by varying at least one communication module or the bandwidths of at least one or more communication modules to correspond to a plurality of external devices or various services.

According to an aspect of the present disclosure, a controlling method of a vehicle comprises setting, by a processor executing computer program stored in a memory, one of a plurality of communication modules as an external module and the remaining communication modules of the plurality of communication modules as internal modules, analyzing, by the processor executing the computer program, a bandwidth by service in the external device and a service table by module related to a service status of each of the internal modules based on a connection of the vehicle to an external device through the external module, and controlling, by the processor executing the computer program, to allocate at least one or more services to a connection between the external module and each of the internal modules based on a result of the analyzing.

In some implementations, controlling to allocate the at least one or more services comprises controlling to allocate the at least one or more services not to exceed a maximum load of the corresponding module of the internal modules.

The method may further include setting one communication module among the plurality of communication modules as an error communication module based on an occurrence of the one communication module being reset due to an emergency processing signal, and allocating a service allocated to the error communication module to other communication modules.

The method may further include re-allocating the service allocated to the other communication modules to the one communication module based on a restoration of the error communication module.

The method may further include controlling to maintain the service allocated to the error communication module at a minimum load based on a failure of allocating the service to the other communication modules.

The method may further include allocating an external message transmitted through an antenna at each of the plurality of communication modules to the external module or the internal modules.

The method may further include detecting a communication status of each of the plurality of communication modules, and identifying a Ping (Alive) signal transmitted and received for communication after the service being activated, determining a normal operation of one communication module of the plurality of communication modules based on a result of transmitting a check message to the one communication module in which the Ping (Alive) signal is not detected, and transmitting the emergency processing signal that requests a reset of the one communication module based on a failure of transmitting the Ping (Alive) signal and responding to the check message.

According to another aspect of the present disclosure, a vehicle can include a plurality of communication modules, and a communication processor configured to control the plurality of communication modules by executing computer program stored in a memory, wherein the communication processor is configured to set one of a plurality of communication modules as an external module and the remaining communication modules of the plurality of communication modules as internal modules, analyze a bandwidth by service in the external device and a service table by module related to a service status of each of the internal modules based on a connection of the vehicle to an external device through the external module, and control to allocate at least one or more services to a connection between the external module and each of the internal modules based on a result of the analyzing.

The communication processor may be configured to control to allocate the at least one or more services not to exceed a maximum load of the corresponding module of the internal modules.

The communication processor may be configured to set one communication module among the plurality of communication modules as an error communication module based on an occurrence of the one communication module being reset due to an emergency processing signal, and allocate a service allocated in the error communication module to the remaining communication modules.

The communication processor may be configured to re-allocate the service allocated to the other communication modules to the one communication module based on a restoration of the error communication module.

The communication processor may be configured to control to maintain the service allocated to the error communication module at a minimum load based on a failure of allocating the service to the other communication modules.

The communication processor may be configured to allocate an external message transmitted through an antenna at each of the plurality of communication modules to the external module or the internal modules.

The communication processor may be configured to detect a communication status of each of the plurality of communication modules and identify a Ping (Alive) signal transmitted and received for communication after the service being activated, determine a normal operation of one communication module of the plurality of communication modules based on a result of transmitting a check message to the one communication module in which the Ping (Alive) signal is not detected, and transmit the emergency processing signal that requests a reset of the one communication module based on a failure of transmitting the Ping (Alive) signal and responding to the check message.

A vehicle including a plurality of communication modules, and a controlling method improve specifications and performances for a user since a single communication module among a plurality of communication modules is exposed to communicate with an external device externally, and an external device communicates with a plurality of communication modules internally.

According to a vehicle including a plurality of communication modules and a controlling method, when a plurality of communication modules are applied, the newly connected service is considered as a physical channel connection and allocated to a new module in the vehicle when another external device is connected. This indicates allocating services based on logical service and communication module load, not a conventional physical distribution method. Therefore, regardless of whether the module is the same or different, or whether the module is high-performance or low-performance the modules may be used together to improve reliability by maximizing the use of resources without deteriorating service quality.

### BRIEF DESCRIPTION OF DRAWINGS

FIG. 1 is a diagram illustrating an example of a vehicle including a plurality of communication modules.

FIG. 2 is a diagram illustrating FIG. 1 in more detail.

FIG. 3 and FIG. 4 are diagrams illustrating an example of a communication module.

FIG. 5 is a diagram illustrating an example of a method of controlling a vehicle including a plurality of communication modules.

FIG. 6 and FIG. 7 are diagrams illustrating an example when an error occurs at a communication module.

### DETAILED DESCRIPTION

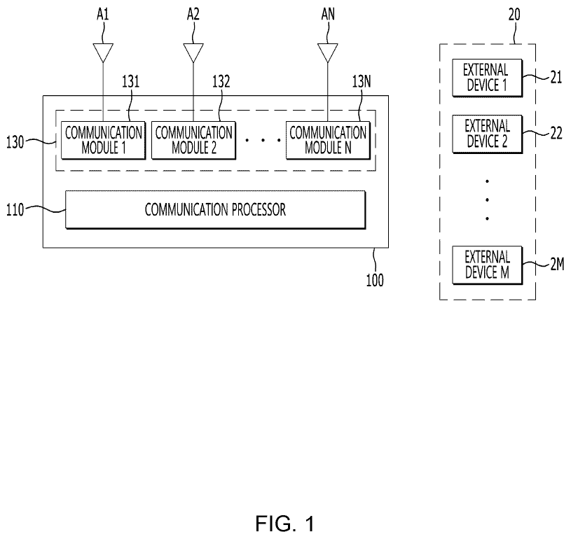

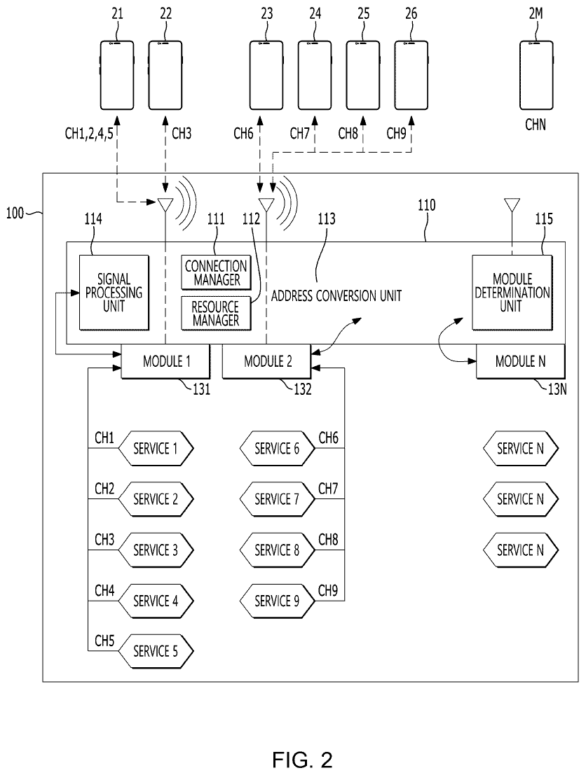

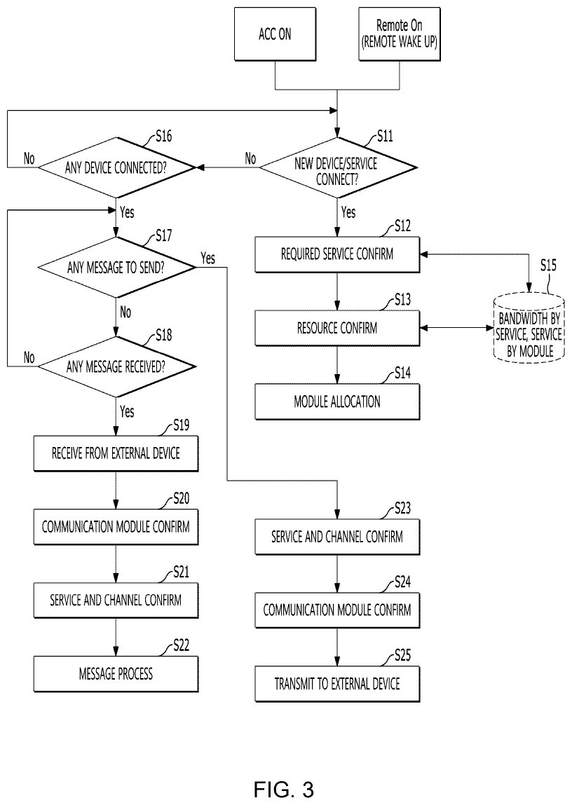

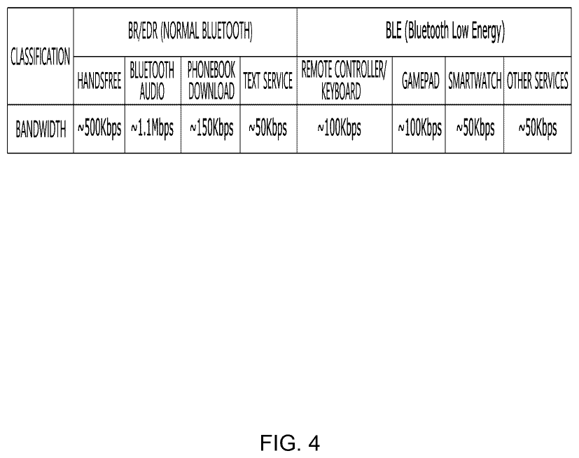

FIG. 1 is a diagram illustrating an example of a vehicle including a plurality of communication modules, and FIG. 2 is a detailed view of FIG. 1. FIG. 3 and FIG. 4 are diagrams illustrating an example of a communication module.

Referring to FIG. 1 and FIG. 2, a vehicle 100 can include a plurality of communication modules 130 and a communication processor 110 for controlling the plurality of communication modules 130.

The plurality of communication modules 130 can be disposed at the vehicle 100 and can transmit and receive predetermined signals to or from a plurality of external devices 20 under the control of the communication processor 110.

The plurality of communication modules 130 can be electrically connected to each other to transmit or receive predetermined signals to or from one another under the control of the communication processor 110. The plurality of communication modules 130 can connect to the plurality of external devices 20 under the control of the communication processor 110, while operating to ensure that the allocated service does not reach its maximum capacity.

The plurality of communication modules 130 can include a first communication module 131 to an nth communication module 13N. The first communication module 131 to the Nth communication module 13N can correspond to antennas A1, A2, . . . , AN, respectively. For example, the first communication module 131 to the nth communication module 13N can respectively correspond to a first antenna A1 to an Nth antenna AN. The plurality of communication modules 130 can be effectively used by identifying the number of the plurality of communication modules 130 and the number of the antenna A1,A2, . . . included in the plurality of communication modules 130, where the number of the plurality of number of the plurality of communication modules 130 and the number of number of the antennas are identical.

The plurality of external devices 20 can include a first external device 21 to an Mth external device 2M. For example, the plurality of external devices 20 may include a smartphone, a smartwatch, a smartpad, etc., but the present disclosure is not limited thereto.

The communication processor 110 can include a connection manager 111, a resource manager 112, an address conversion unit 113, a signal processing unit 114, and a module detection unit 115.

The connection manager 111 can set one of the plurality of communication modules 130 in the vehicle 100 as a main communication module under the control of the communication processor 110, and set other wireless communication modules as sub-communication modules. The main communication module can refer to an external module, and the sub-communication modules can refer to internal modules.

The connection manager 111 can set a Master Bluetooth Device (MBD) in a sub-communication module or an internal module under the control of the communication processor 110. The connection manager 111 can select a resource-rich (high-performance) module from the sub-communication modules under the control of the communication processor 110.

The connection manager 111 can detect the connection status of the main communication module and the sub-communication modules through a service table under the control of the communication processor 110. For example, the connection manager 111 can transmit external messages received from the signal processing unit 114 to internal modules based on the service table under the control of the communication processor 110, and transmit internal messages generated in the vehicle 100 to the signal processing unit 114 based on the service table.

The connection manager 111 can control the main communication module to be exposed to the outside, and the sub-communication modules not to be exposed to the outside under the control of the communication processor 110.

The feature of being exposed to the outside can indicate that the communication module may be detected through the external device 20. The feature of not being exposed to the outside may indicate that the communication module may not be detected through the external device 20. When the vehicle 100 is viewed from the outside, the physical address of the main communication module may be exposed, but the physical addresses of the sub-communication modules may not be exposed to the outside.

For example, the connection manager 111 can allow the main communication module to be electrically connected to the external device 20 based on the main communication module exposed to the outside under the control of the communication processor 110.

The connection manager 111 can detect the bandwidth by service of the connected external device 20 under the control of the communication processor 110. For example, the connection manager 111 can detect a “bandwidth table by service” based on the bandwidth for each service of the external device 20 under the control of the communication processor 110.

The connection manager 111 can detect a remaining resource status for each main communication module, and the sub-communication module under the control of the communication processor 110.

Under the control of the communication processor 110, the connection manager 111 can apply the service status of the sub-communication modules, which are the internal modules, to the service table for each module, and determine whether to allocate the service based on the applied service table for each module.

The connection manager 111 can allocate and connect at least one or more services to the main communication module and each of the sub-communication modules under the control of the communication processor 110.

For example, the connection manager 111 can allocate and connect at least one or more services not exceeding the maximum to the main communication module and each of the sub-communication modules under the control of the communication processor 110.

Under the control of the communication processor 110, the connection manager 111 can determine whether to reset the main communication module and at least one of the sub-communication modules when an emergency processing signal is provided from the module detection unit 115. The emergency processing signal can include information regarding the emergency processing situation of the module.

For example, under the control of the communication processor 110, when it is determined to reset the communication module that provides the emergency processing signal, the connection manager 111 can set the communication module that provides the emergency processing signal as an error communication module.

When the error communication module is set under the control of the communication processor 110, the connection manager 111 can determine whether the error communication module can allocate the services connected to the external device 20 to the main communication module or the sub-communication modules other than the error communication module.

Under the control of the communication processor 110, when it is determined to allocate the services to the main communication module or the sub-communication modules other than the error communication module, the connection manager 111 can allocate the services to the main communication module and the sub-communication modules not to exceed the maximum.

Under the control of the communication processor 110, the connection manager 111, when a reset completion signal is provided from the module detection unit 115, can allocate and connect the services allocated to the main communication module or the sub-communication modules other than the error communication module to a communication module from which the error is recovered. The reset completion signal can include information indicating that the reset of the error communication module is completed.

Under the control of the communication processor 110, the connection manager 111, when the reset completion signal is provided from the module detection unit 115, can determine the error communication module as a communication module that functions as expected.

Under the control of the communication processor 110, when it is determined that the services may not be allocated to the main communication module and the sub-communication modules other than the error communication module, the connection manager 111 can reduce the quality of the services so that the services can be maintained at the minimum, thereby preventing the external device 20 from determining that the connection is disconnected.

Under the control of the communication processor 110, when the error communication module needs to be reset and a communication module (including the communication module and the sub-communication modules) to which the service currently allocated and connected to the error communication is transmitted for a predetermined period of time is not present, the connection manager 111 can control to reduce the quality of the service to maintain at the minimum, so that the external device 20 may not determine that the connection is disconnected. For example, the external device 20 can determine that the connection is disconnected when communication is not performed for longer than 5 seconds. To prevent the external device 20 from determining the disconnection, the connection manager 111 can transmit a reply message once per second to the external device 20 to prevent disconnection under the control of the communication processor 110.

The resource manager 112, under the control of the communication processor 110, can record and manage the load available for the main communication module and the plurality of sub-communication modules.

The resource manager 112, under the control of the communication processor 110, can determine the load of new service connected before a new external device is connected, and determine whether to allocate the new service to the main communication module and one of the plurality of sub-communication modules based on the determined result.

For example, as shown in FIG. 3 and FIG. 4, the resource manager 112, under the control of the communication processor 110, can allocate the service to the main communication module and each of the sub-communication modules based on database. The database can store a service table indicating the load for each service, the maximum load for the main communication module and each of the sub-communication modules, and current loads of the main communication module and each of the sub-communication modules.

The resource manager 112, under the control of the communication processor 110, can classify the main communication module and the sub-communication modules based on the properties under the control of the communication processor 110. For example, as shown in FIG. 3, the resource manager 112 can classify the main communication module and the sub-communication modules into a Bluetooth Basic-Rate/Enhanced-Data-Rate (Bluetooth BR/EDR) module and a Bluetooth Low Energy (BLE)-dedicated module based on the properties under the control of the communication processor 110.

The resource manager 112, under the control of the communication processor 110, can allocate a BR/EDR service to the BR/EDR module. The resource manager 112 can preferably allocate a BLE service to the BLE-dedicated module under the control of the communication processor 110.

For example, the BR/EDR service can include hands-free, Bluetooth audio, phone book download, text services, etc. based on the bandwidth DB for each service. The BLE service can include a remote controller/keyboard, a gamepad, a smartwatch, and other services based on bandwidth.

The Bluetooth bandwidth may be approximately 2 to 3 Mbps, but it may be set to about 1.5 Mbps due to interference in the surrounding area. For example, the BR/EDR module can be designed to have a bandwidth of approximately 2 Mbps, and the BLE module can be designed to have a bandwidth of approximately 1 Mbps.

Under the control of the communication processor 110, when the resource of the module is less than 90% while the new service is connected, the resource manager 112 can connect the service to the module, and when the resource of the module exceeds 90% (a predetermined range), the resource manager 112 can connect the service to another module.

However, the present disclosure is not limited thereto, under the control of the communication processor 110, when using sub-communication modules with the same properties, the resource manager 112 can manage resources by alternating a first sub-communication module or a second sub-communication module whenever a new service is connected.

The resource manager 112, under the control of the communication processor 110, can operate differently depending on whether the properties of the main communication module or sub-communication modules are the same or different.

Under the control of the communication processor 110, the address conversion unit 113, when the plurality of communication modules 130 are applied to the vehicle 100, can determine one of the plurality of communication modules 130 as a main communication module.

Under the control of the communication processor 110, the address conversion unit 113 can allow the services performed in the plurality of sub-communication modules to appear to perform in the main communication module by using a BD Address of the main communication module. The address conversion unit 113, under the control of the communication processor 110, can distribute the external message provided from the outside of the vehicle 100 to the sub-communication module, which is internal module, through the main communication module.

Under the control of the communication processor 110, when the internal message or the service message transmitted from the sub-communication module is provided to the external device 20, the address conversion unit 113 can convert the internal message or the service message into the BD address of the main communication module to be provided to the external device 20.

The address conversion unit 113, under the control of the communication processor 110, can convert the external message or the internal message into the BD address of the main communication module based on the service table.

In some implementations, it is possible that the Friendly name (the name displayed to the user as the device name) remains the same, and that the physical address is also identical, rather than being different.

In addition, the address conversion unit 113, under the control of the communication processor 110, can refer to the service table for the main communication module and each of the sub-communication modules to use a BD Address (Bluetooth physical address) to communicate with the external device 20 as an MBD address.

Referring to FIG. 4, the address conversion unit 113, under the control of the communication processor 110, can set the main communication module and each of the sub-communication modules as channels. The address conversion unit 113, under the control of the communication processor 110, can operate to allow each set channel CH to open and close for communication (control, information, service data) for each service. Therefore, it may be easily identified which service communication module the service is connected to by setting the main communication module and each of the sub-communication modules as channels by using the address conversion unit 113.

For example, the address conversion unit 113, under the control of the communication processor 110, can use a service table DB by communication module. For example, as shown in FIG. 4, Bluetooth audio 1/blue tooth audio 2 may not be used simultaneously but only one may be selectively used, so that only a single Bluetooth audio may be used for the entire load calculation. The processor 110 can vary channels, use resources, and available resources each time the service is connected.

Therefore, in some implementations, it may be possible to identify the signal (service use data) from the external device 20 connected to the outside and determine which communication module the signal is sent to through the identified channel.

In addition, it may be easily possible to identify from which communication module each service performed in the communication module is provided by using the channel information.

Under the control of the communication processor 110, it may be possible to identify destination information (module, service) from the outside, and information from the inside to the outside (the external device 20, service) by using the address conversion unit 113. Therefore, data may be output through the communication module corresponding to the channel.

When the external message is received, under the control of the communication processor 110, it may be possible to identify the channel CH by using the address conversion unit 113, determine to which communication module to send, and transmit the message to the communication module.

The signal processing unit 114, under the control of the communication processor 110, can distribute the external messages received from the antennas of the plurality of communication modules 130 to the internal modules, and communicate the internal messages through the antennas connected to the outside to provide the service.

The signal processing unit 114, under the control of the communication processor 110, can be linked with the address conversion unit 113.

The communication processor 110 can allocate the external message transmitted through the antenna provided in each communication module to the internal module by controlling the connection manager 111 and transmit the internal message to the antenna of the communication module by controlling the connection manager 111 and the signal processing unit 114.

Under the control of the communication processor 110, the module detection unit 115 can monitor the communication status of each of the plurality of communication modules 130 and identify a Ping (Alive) signal exchanged for communication when the service is activated.

Under the control of the communication processor 110, the module detection unit 115 can identify whether the communication module operates properly by sending a check message to the communication module for which the Ping (Alive) signal is not detected.

When a specific communication module fails to transmit a Ping (Alive) signal monitored in a specific communication module and respond to the check message transmitted from the module detection unit 115, under the control of the communication processor 110, the module detection unit 115 can transmit an emergency processing signal requesting reset of the corresponding communication module to the connection manager 111. The specific communication module can be an error communication module.

Under the control of the communication processor 110, when a specific communication module is recovered after the reset command of the specific communication module to function as expected, the module detection unit 115 can transmit a reset completion signal to the connection manager 111. The module detection unit 115 can continue to monitor the communication status of the specific communication module again under the control of the communication processor 110.

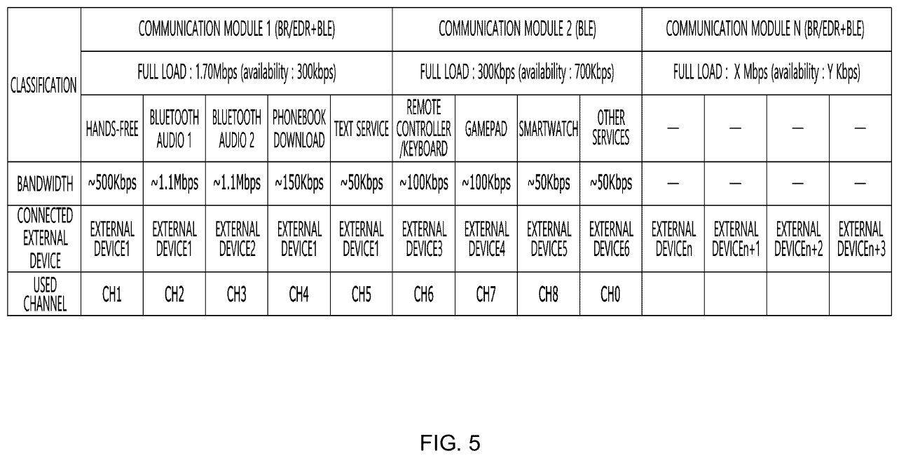

FIG. 5 is a diagram illustrating an example of a method for controlling a vehicle including a plurality of communication modules.

Referring to FIG. 5, the communication processor 110 can perform a control operation as described below.

The communication processor 110, when the engine of the vehicle 100 is turned on or the remote controller is detected as being on, can identify a new device or a service connection in the communication module at step S11. The new device can include the external device 20.

When the new device or the new service is connected, the communication processor 110 can identify the requested service related to the connected new device at step S12.

The communication processor 110 can apply the requested service to the bandwidth by service or the service by communication module at step S15 and apply resources, etc. at step S13.

The communication processor 110 can allocate and connect the applied services to the plurality of communication modules 130 at step S14. The description thereof will be omitted since it is explained above with respect to FIGS. 1 to 4.

When the new device is not connected, the communication processor 110 can identify whether the external device 20 other than the new device is connected at step S16.

The communication processor 110 can identify whether the internal message to be transmitted to the connected external device 20 is present at step S17.

When it is determined that the internal message to be transmitted to the connected external device 20 is present at step S17 (yes), the communication processor 110 can identify the service, the channel, etc. related to the internal message at step S23, and determine a single communication module among the plurality of communication modules 130 at step S24.

The communication processor 110 can transmit the internal message to the external device 20 by using the determined communication module at step S25.

When it is determined that the internal message to be transmitted to the connected external device 20 is not present at step S17 (no), the communication processor 110 can determine whether the external message transmitted from the external device 20 is present at step S18.

The communication processor 110 can maintain the connection to the connected external device 20 although it is determined that the external message transmitted from the external device 20 is not present.

The communication processor 110 can receive the external message from the external device 20 when it is determined that the external message transmitted from the external device 20 is present at step S19.

The communication processor 110 can analyze the communication module to which the external message is allocated at step S20, and identify the service and channel related to the external message corresponding to the analyzed result at step S21.

The communication processor 110 can process the external message at step S22.

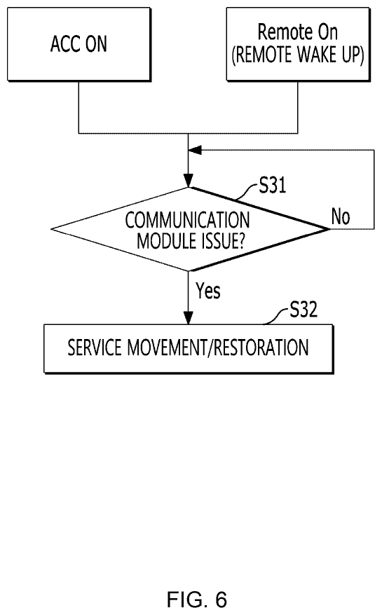

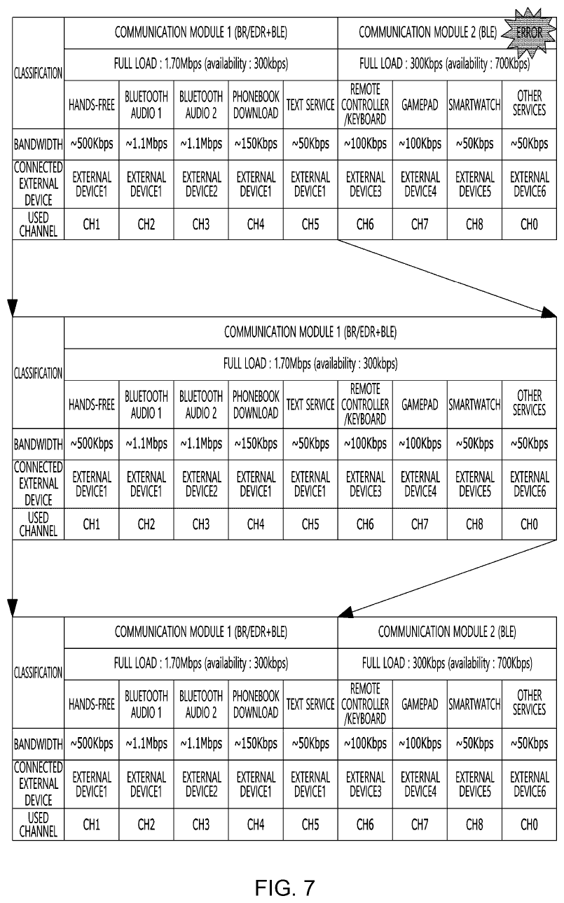

FIG. 6 and FIG. 7 are diagrams illustrating an example when an error occurs in a communication module.

Referring to FIG. 6, the communication processor 110 can, when the engine of the vehicle 100 is turned on, or the remote controller is detected as being turned on, determine whether each of the plurality of communication modules 130 functions as expected at step S31.

The communication processor 110 can identify whether the error issue is present among the plurality of communication modules 130 in real-time, and when it is determined that at least one of the plurality of communication modules 130 is an error, the communication processor 110 can set the communication module in which the error occurs as an error communication module.

Referring to the upper table in FIG. 7, a communication module 1 may operate properly, and a communication module 2 may operate abnormally with an error occurring. The communication module 2 can be set as an error communication module.

The communication processor 110, when the error communication module is set, can determine whether it is possible for the error communication module to allocate the service provided by being connected to the external device 20 to the communication modules other than the error communication module at step S32.

The communication processor 110, when it is determined that the service is allocated to the communication modules other than the error communication module, can allocate the service to other communication modules not to be the maximum.

In the middle table in FIG. 7, the communication module 1 can function as expected, and can operate by receiving the service provided from the communication module 2.

The communication processor 110 can control to transmit the service connected to the set error communication module to the communication module that operates properly. When the reset completion signal is provided from the module detection unit 115, the communication processor 110 can reallocate the services allocated to the other communication modules to be recovered to the error communication module from which the error is recovered.

As shown in the lower table in FIG. 7, when the error problem of the communication module 2 is resolved and the communication module 2 functions as expected, the communication module 1 can restore the services from the communication module 2 to the communication module 2.

The present disclosure may improve specifications and performance by applying a plurality of communication modules when wireless communication of the vehicle 100 is to solve the limitations of services that operate simultaneously due to hardware limitations, by exposing only one communication module to the device connected to the outside and allowing internal communication with multiple communication modules.

In addition, in some implementations, when a plurality of communication modules are applied, the newly connected service can be determined as a physical channel connection and allocated to a communication module inside the vehicle 100 each time another external device is connected. By allocating services based on the load of the communication module, which is a logical service standard rather than a physical distribution method, the communication module may operate together with the same communication modules, different communication modules, high-performance communication modules, and low-performance communication modules, thereby maximizing the use of resources without deteriorating service quality.

The present disclosure may be implemented as computer-readable code on a program-recorded medium. The computer-readable media may include all types of recording devices that store data that is read by a computer system. Examples of computer-readable media may include Hard Disk Drive (HDD), Solid State Disk (SSD), Silicon Disk Drive (SDD), ROM, RAM, CD-ROM, magnetic tape, floppy disk, optical data storage device, etc.

What is claimed is:

1. A controlling method of a vehicle performed by a processor, the controlling method comprising:
determining one of a plurality of communication modules as an external module and the remaining communication modules of the plurality of communication modules as internal modules;
analyzing, based on a connection between the vehicle and an external device through the external module, a bandwidth of each service of the external device and a service table for each module regarding current status of services in the internal modules; and
controlling, based on a result of the analysis, to allocate and connect at least one or more services to each of the external module and the internal modules.

2. The method as claimed in claim 1, wherein controlling to allocate and connect the at least one or more services comprises controlling to allocate the at least one or more services not to exceed a maximum load of a corresponding module of the internal modules.

3. The method as claimed in claim 2, further comprising:
determining one communication module among the plurality of communication modules as an error communication module based on the one communication module being reset from an emergency processing signal, and
allocating a service allocated to the error communication module to other communication modules.

4. The method as claimed in claim 3, further comprising re-allocating the service allocated to the other communication modules to the one communication module based on a restoration of the error communication module.

5. The method as claimed in claim 4, further comprising controlling to, based on allocating the service to the other communication modules being failed, maintain the service allocated to the error communication module at a minimum load.

6. The method as claimed in claim 5, wherein further comprising allocating an external message transmitted through an antenna at each of the plurality of communication modules to the external module or the internal modules.

7. The method as claimed in claim 3, further comprising:
detecting a communication status of each of the plurality of communication modules, and identifying a ping signal transmitted and received for communication after the service is activated,
determining, based on a result of transmitting a check message to the one communication module in which the ping signal was not detected, that one communication module of the plurality of communication modules is functioning as expected, and
transmitting the emergency processing signal that requests a reset of the one communication module based on a failure of transmitting the ping signal and responding to the check message.

8. A vehicle comprising:
a plurality of communication modules; and
a communication processor configured to control the plurality of communication modules by executing a computer program stored in a memory,
wherein the communication processor is configured to execute the computer program to perform operations comprising:
determining one of a plurality of communication modules as an external module and the remaining communication modules of the plurality of communication modules as internal modules,
analyzing, based on a connection between the vehicle and an external device through the external module, a bandwidth of each service of the external device and a service table for each module regarding current status of services in the internal modules, and
controlling, based on a result of the analysis, to allocate and connect at least one or more services to each of the external module and the internal modules.

9. The vehicle as claimed in claim 8, wherein controlling to allocated and connect the at least one or more services comprises controlling to allocate the at least one or more services not to exceed a maximum load of a corresponding module of the internal modules.

10. The vehicle as claimed in claim 9, wherein the operations further comprise:
determining one communication module among the plurality of communication modules as an error communication module based on the one communication module being reset from an emergency processing signal, and
allocate a service allocated in the error communication module to the remaining communication modules.

11. The vehicle as claimed in claim 10, wherein the operations further comprise re-allocating the service allocated to the other communication modules to the one communication module based on a restoration of the error communication module.

12. The vehicle as claimed in claim 11, wherein the operations further comprise controlling to, based on allocating the service to the other communication modules being failed, maintain the service allocated to the error communication module at a minimum load.

13. The vehicle as claimed in claim 12, wherein the operations further comprise allocating an external message transmitted through an antenna at each of the plurality of communication modules to the external module or the internal modules.

14. The vehicle as claimed in claim 10, wherein the operations further comprise:
detecting a communication status of each of the plurality of communication modules and identifying a ping signal transmitted and received for communication after the service is activated,
determining, based on a result of transmitting a check message to the one communication module in which the ping signal was not detected, that one communication module of the plurality of communication modules is functioning as expected, and
transmit the emergency processing signal that requests a reset of the one communication module based on a failure of transmitting the ping signal and responding to the check message.
